(19) United States
(12) Patent Application Publication
(10) Pub. No.: US 2004/0222065 A1
(43) Pub. Date: Nov. 11, 2004

(54) Wire rope type belt cleaning device for belt conveyer facilities

(75) Inventor: Chiharu Meguro, Osaka-shi (JP)

Correspondence Address: GRIFFIN & SZIPL, PC, SUITE PH-1, 2300 NINTH STREET, SOUTH, ARLINGTON, VA, 22204, US

(73) Assignee: Kinki Estate Co., Ltd., Osaka-shi (JP)

(21) Appl. No.: 10/842,453

(22) Filed: May 11, 2004

(30) Foreign Application Priority Data
May 9, 2003 (JP) 2003-168478

(51) Int. Cl. B65G 45/12

(52) U.S. Cl. 198/497; 15/256.5

(57) ABSTRACT

The present invention comprises a wire rope type cleaning device for a conveyor belt, the device having extended service life, improved cleaning efficiency, and reduced maintenance needs. The belt cleaning device comprises a wire rope and a plurality of wear-resistant removing chips fitted to the rope so that they are adjacent to each other and contact the conveyor belt, running the full width of the conveyor belt. The belt cleaning device is disposed at the front part of the conveyor head pulley at an inclination angle θ relative to the axis of the head pulley.

### CROSS-REFERENCE TO RELATED APPLICATIONS

This application claims benefit under 35 U.S.C. 119(a) of Japanese Patent Application No. 2003-168478, filed on May 12, 2003.

### BACKGROUND OF THE INVENTION

1. Field of the Invention

The present invention is concerned with improvements in a wire rope type belt cleaning device for belt conveyer facilities commonly used in steel making plants, mines and the like. The present invention is also concerned with a wire rope type belt cleaning device for belt conveyer facilities which can be manufactured simply and at a low cost, and easily mounted, ensuring a long service life and almost perfect cleaning of a conveyer belt without damaging it.

2. Background Art

Belt conveyer facilities are widely used in various kinds of factories and the like. The facilities are normally equipped with a belt cleaning device without exception, and various types of belt cleaning devices have been in practical use. Some of them commonly seen are, for example, a blade type cleaner (or a chip type cleaner) A as illustrated in FIG. 12 and FIG. 13, a brush type cleaner B as illustrated in FIG. 14, or a wire type cleaner C as illustrated in FIG. 15.

However, it is noticed that considerably large space is required beneath the conveyer pulley 1 for mounting a belt cleaner with the belt cleaning device wherein the blade type cleaner A is employed as illustrated in the aforementioned FIG. 12 and FIG. 13 and the belt cleaning device wherein the brush type cleaner B is employed as illustrated in the aforementioned FIG. 14. Accordingly, it causes various inconvenience of requiring to raise the mounting position of a supporting shaft 1a of the conveyer head pulley 1, or to upsize a storage box (not illustrated) to house the head pulley 1.

Considerably fast wear and tear is noticed while the blade type cleaner A or the brush type cleaner B is used, thus requiring frequent replacement of blades or brushes. And, maintenance of the cleaners is found time-consuming and costly.

Furthermore, a conveyer belt 2 can be easily damaged by the blade with the belt cleaning device wherein a blade type cleaner A is employed. And, when an effort is given to prevent the conveyer belt from being damaged, sufficient cleaning of the belt 2 cannot be expected.

In addition, so-called cleaning performance is found low with the belt cleaning device equipped with the brush type cleaner B because its cleaning function to the belt 2 is relatively weak. The other problem is that a revolving driving mechanism (for example, a motor 3) is needed to make the brush type cleaner B rotate.

Contrary, a belt cleaning device C equipped with a wire type cleaner C as illustrated in the aforementioned FIG. 15 employs two pieces of wire rope to make a cleaner C, thus making it possible that large space is not required to amount a belt cleaning device, and belt conveyer facilities are substantially downsized.

The aforementioned FIG. 15 and FIG. 16 are a top view and a front view to illustrate a state of mounting a belt cleaning device disclosed in Japanese patent document S54-47784. In FIG. 15 and FIG. 16, 1 designates a conveyer head pulley, 2 a conveyer belt, 4 a supplementary roller, 5a conveyer driving motor, 5b a deceleration mechanism, 6 a wire rope to remove adherents, 7 a chute, 7b a base, 8 an angle adjustment device, and 9 a wire tension device.

The aforementioned wire rope holding a certain declination angle θ is pulled with certain tensile strength to forcefully make it contact with the outer surface of the conveyer belt 2. That is, one end of the wire rope is fixed to the angle adjustment device 8, while the other end of the wire rope 6 is held by means of a wire tension device 9 permitting the adjustment of tensile strength.

Furthermore, the aforementioned angle adjustment device 8 whereto one end of the wire rope 6 is fixed is fixed to the base 7b permitting the movement along the peripheral surface of the conveyer head pulley 1, making it so structured that the inclination angle θ in FIG. 12 can be adjusted by shifting the fixing position of the angle adjustment device 8 in FIG. 17.

The advantage of the belt cleaning devices illustrated in the said FIGS. 15, 16 and 17 is that large space is not required for installation as mentioned above, while there are found some problems as below:

a. A wire rope 6 is so made by twisting a plural number of thin solid wires that the solid wire is easily worn out by frictional force against the conveyer belt, and cut off one after another.

b. The outer surface of the wire rope 6 is made smooth carrying no edge. Thus resulting in poor capability of removing adherents fastened to the conveyer belt 2.

c. It is found more often that the outer surface of the conveyer belt 2 surrounding a head pulley 1 is not flat-shaped to the lateral axis but arc-shaped. Accordingly, it becomes difficult for the wire rope 6 to be contacted with the entire outer surface of the conveyer belt 2, thus making it hard to perform thorough removal of adherents fastened to the conveyer belt 2. (Adherents in the center part of the conveyer belt can be removed but ones in the both ends of the conveyer belt cannot be fully removed.)

Relevant publications include Japanese patent documents S54-47784 and H10-226416.

### SUMMARY OF THE INVENTION

As stated above, various problems remain unsolved with a belt cleaning device wherein a wire type cleaner C is employed. Among others, it is found especially difficult to perform cleaning of the entire area of the conveyer belt 2 uniformly and with high peeling-off strength.

It is a primary object of the present invention to solve problems such as aforementioned a, b and c related to a belt cleaning device wherein a conventional wire type cleaner is employed, thus providing a wire rope type belt cleaning device in belt conveyer facilities wherewith large space is not required to install a belt cleaning device, peeling-off and removal of adherents can be performed surely and uniformly with a close contact with the outer surface of the conveyer belt 2 and over the entire area to the lateral axis of the conveyer belt 2, and further many hours of operation can be achieved continuously without damaging the conveyer belt 2.

The inventor of the present invention has come to an idea of peeling off and removing adherents fastened to the outer surface of the conveyer belt 2 by means of a plural number of wear-resistant, adherent-removing chips formed with hard materials such as hard ceramics or superhard steel supported on the wire rope adjacent to each other so that adherents fastened to the outer surface of the conveyer belt 2 are peeled off and removed by the said plural number of wear-resistant removing chips, thus enhancing the peeling-off capability (cleaning capability) of adherents fastened to the belt conveyer 2 and also improve the service life, while making use of excellent characteristics of “smaller space needed for installation” born by the wire type cleaner C.

Furthermore, the inventor of the present invention has prepared various shapes of removing chips for adherents and conducted many experiments on peeling and removing (or cleaning) adherents using the conveyer belt 2.

The present invention is a creation based on the aforementioned idea and the results of various experiments.

In a first preferred embodiment of the invention is a wire rope type belt cleaning device for belt conveyer facilities wherein it is so constituted that the front part of the conveyer head pulley is installed with a belt cleaner having an inclination angle θ to its axis, and the said belt cleaner is brought into a contact with the conveyer belt, that the aforementioned belt cleaner comprises a wire rope and a plural number of wear-resistant removing chips fitted to the said wire rope in a state of being adjacent to each other in the full length to the lateral axis of the conveyer belt.

In a second preferred embodiment of the invention, the first embodiment is so constituted that said removing chips are equipped with a main body made of a nearly-square-shaped thick plate, a bore horizontally made in the center of the main body for the wire rope to be inserted, and recesses formed on the both sides of the main body.

In a third preferred embodiment of the invention, said removing chips are made of a ceramic and fitted permitting rotation around the wire rope as a core shaft.

In a fourth preferred embodiment of the invention, each removing chip comprises a main body made of a nearly-square-shaped thick plate and which side is arc-shaped or trapezoid-shaped, a bore made horizontally in the center of the main body for the wire rope to be inserted, and a recess formed only on the side of the main body opposing to the conveyer belt.

In a fifth preferred embodiment of the invention, the belt cleaner which is arranged to have an inclination angle larger than 20°.

In a sixth preferred embodiment of the invention, the belt cleaner so arranged in a V-shape when observed from the front of the conveyer belt device.

In a seventh preferred embodiment of the invention, one end of the belt cleaner is fixed to the fixing device installed in the belt conveyer facility, and the other end of the belt cleaner is fixed to the tension device installed in the belt conveyer facility permitting an adjustment of tensile strength.

In an eighth preferred embodiment of the invention, both ends of the belt cleaner arranged in a V-shape is fixed to a tension device installed in the belt conveyer facility permitting an adjustment of tensile strength, and its center part is fixed to the fixing device installed in the belt conveyer facility.

### BRIEF DESCRIPTION OF THE DRAWINGS

FIG. 1 is a perspective view illustrating a belt cleaning device of the present invention.

FIG. 2 is a perspective view of a wear-resistant removing chip from the belt cleaning device.

FIG. 3 shows a wear-resistant removing chip in contact with a conveyor belt.

FIGS. 4 and 5 are a side view and a front view, respectively, of another embodiment of the removing chip.

FIGS. 6 and 7 are side views of two additional embodiments of the removing chip.

FIG. 8 illustrates a mounting of the present invention.

FIGS. 9 and 10 illustrate another embodiment of the belt cleaning device of the present invention.

FIG. 11 illustrates yet another embodiment of the belt cleaning device of the present invention.

FIGS. 12 and 13 show a blade type belt cleaner.

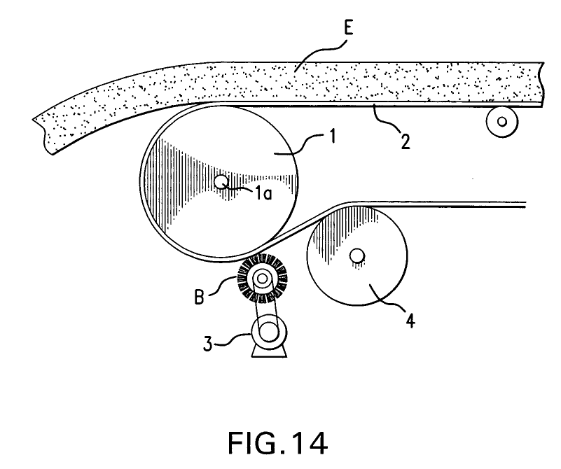

FIG. 14 shows a brush type belt cleaner.

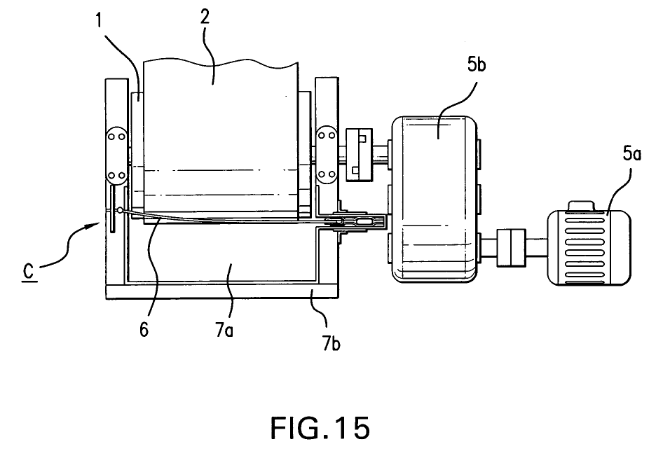

FIGS. 15, 16, and 17 show a wire type belt cleaner.

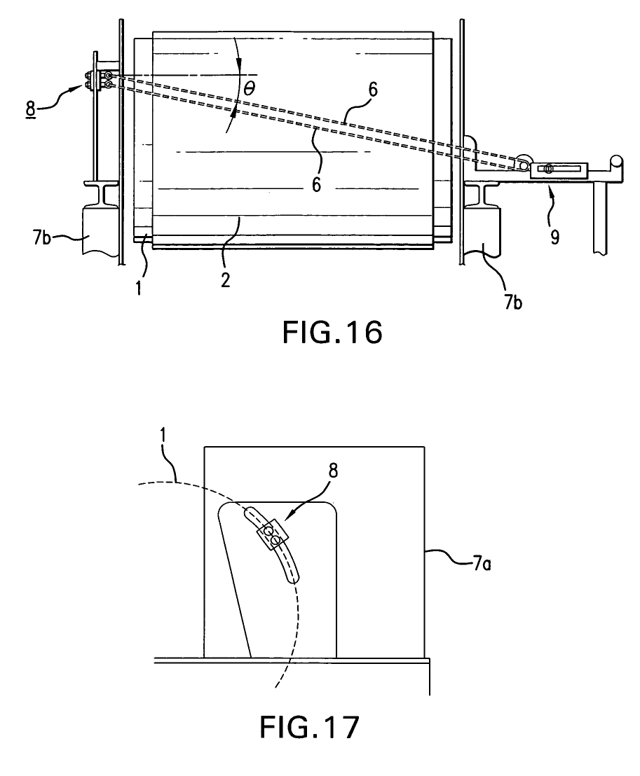

### DETAILED DESCRIPTION OF THE INVENTION

With the present invention, not only is little space required for the installation of a belt cleaning device, but also that the wear speed of a removing chip is remarkably slowed down, and its service life can be extended 3-4 times compared with those of conventional belt cleaning devices

Also, cleaning effects are remarkably improved, and adherents can be almost perfectly removed even when the outer surface of the conveyer belt is rough and uneven.

Furthermore, there is required almost no adjustment for the belt cleaning device, thus realizing a so-called maintenance free belt cleaning device

### Best Mode of Carrying Out the Invention

The following embodiments of the present invention are described with reference to the drawings hereunder.

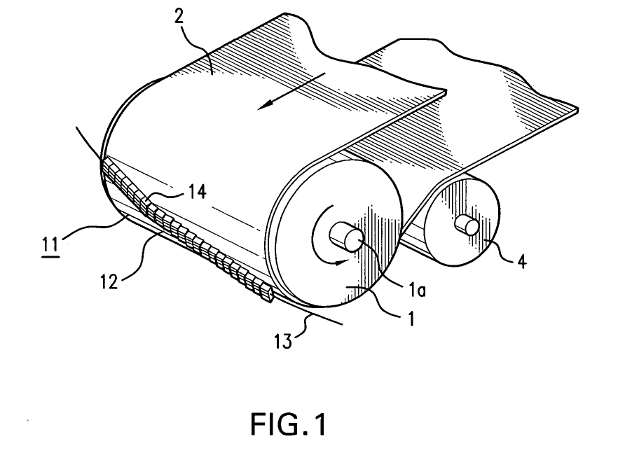

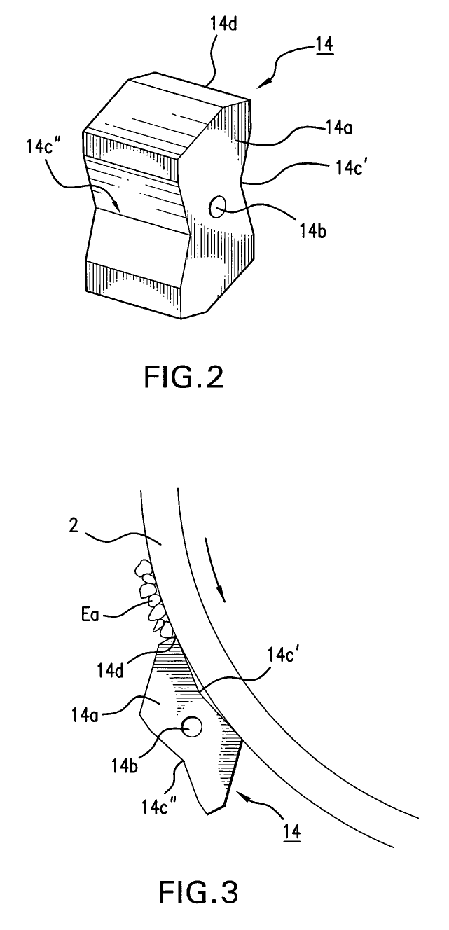

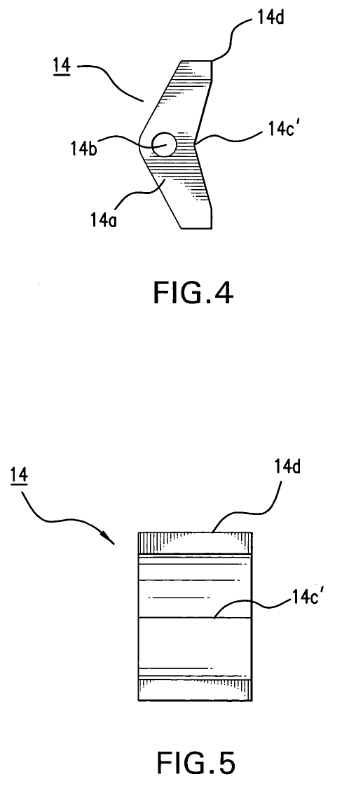

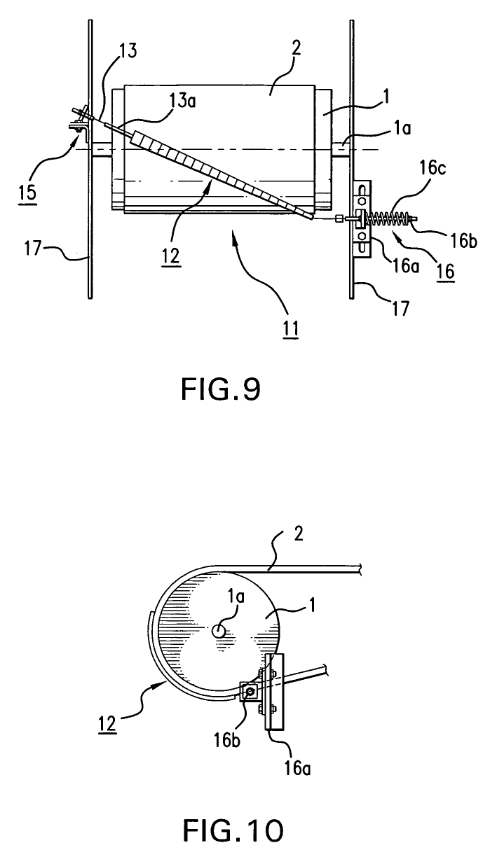

FIG. 1 is a perspective view to illustrate the outline of a belt cleaning device according to the present invention. FIG. 2 is a perspective view of a wear-resistant removing chip to form a belt cleaner. FIG. 3 is an explanatory drawing to illustrate a state of the wear-resistant removing chip being in contact with a conveyer belt. FIG. 8 is a front view of a belt cleaning device according to the first embodiment.

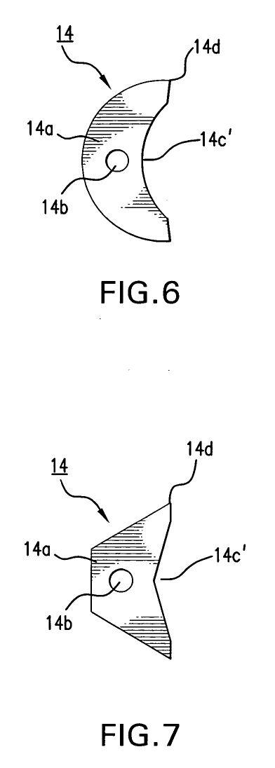

In FIG. 1, FIG. 2, FIG. 3 and FIG. 4, 11 designates a belt cleaning device, 1 a conveyer head pulley, 1a a supporting shaft of the head pulley, 2 a conveyer belt, 4 a supplementary roller, 12 a belt cleaner, 13 a wire rope, 14 a wear-resistant removing chip, 15 a fixing device for the belt cleaner, and 16 a tension device. The chip 14 removes adherents Ea.

The belt cleaning device 11 according to the present invention is formed with a belt cleaner 12, a fixing device to fix one side of the belt cleaner, and a tension device to fix the other side of the belt cleaner permitting adjustments of tensile strength.

And, the aforementioned belt cleaner 12 is formed with a wire rope B and a plural number of wear-resistant removing chips 14 adjacent thereto to be inserted.

A wire rope with a diameter of about 5-10 mm made of a plural number of stainless steel twisted is used for the aforementioned wire rope 13. The length is appropriately chosen depending on the width and the like of the conveyer belt 2.

As illustrated in FIG. 2 and FIG. 3, the aforementioned removing chip 14 is formed by preparing a bore 14b in the center of the main body made by a thick plate rectangle-shaped in the front view and rhombus-shaped in the side view for a wire rope to be inserted laterally. And further by preparing recesses 14c′ and 14c″ on the side opposing to the conveyer belt 2 and on the opposite side thereto respectively.

That is, the main body 14a of the removing chip 14 is formed anti-symmetrically to the bore 14b for the wire rope to be inserted, thus making the other recess 14c″ reaches a position opposing to the conveyer belt 2 when the main body 14a rotates for 180° from a state shown in FIG. 3 as the result.

The said wear-resistant removing chip 14 is made of WC—Co hard metal with high hardness and excellent wear resistance, or ceramics with excellent heat resistance and wear resistance. With the embodiment, the removing chip 14 is made of Al₂O ceramics.

More concretely, in the embodiment, a removing chip is formed in a near-square shape having outer dimensions of 50 mm in height, 40 mm in width, and 15 mm in thickness equipped with a bore having a diameter of 7 mm. to suite for a conveyer belt having a width of 500-1500 mm.

Also, to suit a conveyer belt 2 having a width of 500-1500 mm, 10-50 pieces of the aforementioned wear-resistant removing chips 14 adjacent to each other are penetrated through the wire rope 13.

Furthermore, a plural number of wear-resistant removing chips 14 penetrated adjacent to each other in sequence through the wire rope 13 are prevented from lateral movements in such a manner that sheath pipes 13a, 13a inserted from the both sides of the wire rope fix the wire rope 13 by means of clips (not illustrated).

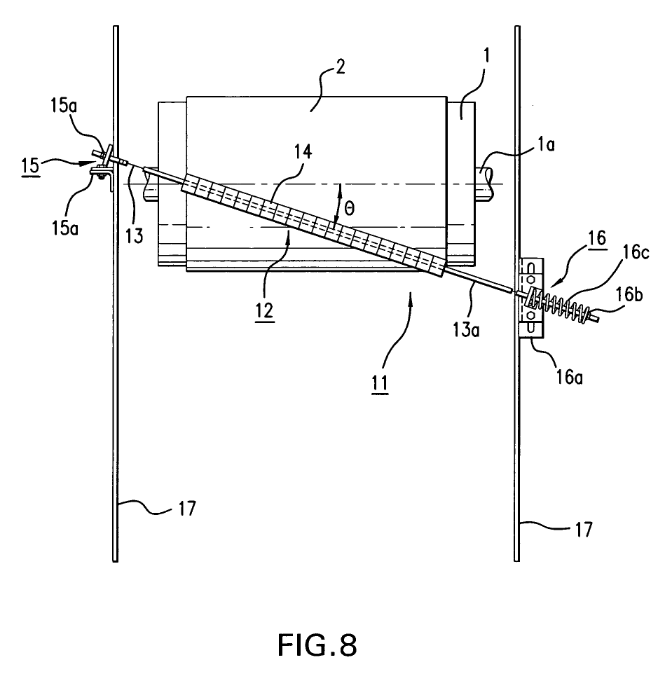

FIG. 4 and FIG. 5 are a side view and a front view to illustrate the second embodiment of a removing chip 14 to be employed with a belt cleaner 12 according to the present invention. FIG. 6 is a side view to illustrate the third embodiment of a removing chip 14. FIG. 7 is a side view to illustrate the fourth embodiment of a removing chip 14.

The removing chips 14 in the second embodiment to the forth embodiment having an outer dimensions of approx. 50 mm in height, approx. 40 mm in width and approx. 15 mm in thickness are equipped with a recess 14c′ only on the side opposing to the conveyer belt 2, and a bore 14b for the wire rope 13 to be inserted in the center to its height.

In FIG. 4 to FIG. 8 inclusive, 14a is a main body with a square shape in a plan view, an arc shape or a trapezoid shape in a side view, and 14c′ is a recess made on the side opposing to the conveyer belt 2. The material used for the main body 14a is same as that for the removing chip 14 in FIGS. 1 to 3 inclusive.

Next, an explanation is made on the attachment of the aforementioned belt cleaner 12. Referring to FIG. 8, a fixing device 15 of the belt cleaner 12 is attached to one side, and a tension device 16 of the belt cleaner 12 to the other side of the frame body of the storage box (or the frame body of a chute for the conveyed E) to house a conveyer head pulley for the belt conveyer facility respectively.

As illustrated in FIG. 8, the aforementioned fixing device 15 is fixed at a slightly upward position to the supporting shaft 1a of the head pulley 1, and formed by a bracket 15a, a dead-end bolt/nut 15b and the like.

The tension device 16 of the aforementioned belt cleaner is fixed at slightly downward position to the underside of the head pulley 1, and formed by a bracket 16a, a tension adjustment spring 16c, a tension adjustment bolt/nut 16b and the like.

As illustrated in FIG. 8, it is desirable that the aforementioned belt cleaner 12 is attached with an inclination angle θ of about 20-30° to the horizontal supporting shaft 1a of the conveyer head pulley 1.

Adherents fastened to the outer surface of the belt conveyer 2 are smoothly peeled off and removed with the tip edge 14d of the removing chip 14 closely contacted to the outer surface of the belt conveyer 2 with the inclination angle θ of 20-30°.

It has been experimentally demonstrated that there is occurred vibration due to frictional force between the removing chip 14 and the conveyer belt 2 in the event that the inclination angle is smaller than 20°.

It has been also demonstrated that adhesiveness of the removing chip 14 to the belt conveyer 2 is improved and removing capability of adherents is remarkably enhanced by making recesses 14c′, 14c″ on the side where the removing chip 14 contacts with the outer surface of the belt conveyer 2.

Furthermore, the removing chip 14 is supported to the wire rope penetrating through a bore 14b made in the center permitting rotation, and rotates for 180° around the wire rope as a core shaft, and restores to the original position in the event that frictional resistance becomes excessive at the time when it makes a contact with the conveyer belt 2. Accordingly, there will be occurred no damage on the removing chip 14 due to the aforementioned resistance and the like caused by the excessive contact.

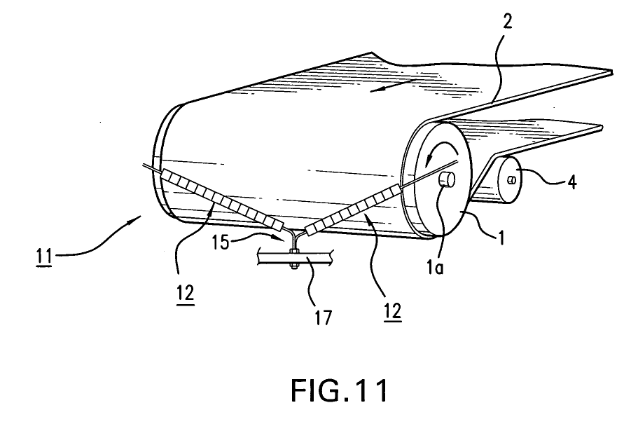

FIG. 9 and FIG. 10 are a front view and a side view to illustrate the second embodiment of the belt cleaning device according to the present invention. As apparent from FIG. 10, the tension device 16 of the belt cleaner is attached to a position forward from directly below the supporting shaft 1a of the conveyer belt pulley. That is, a belt cleaner 12 is held in such a manner that it wraps partially around the circumference of the head pulley 1, thus enhancing contact of the removing chips 14 with the conveyer belt 2.

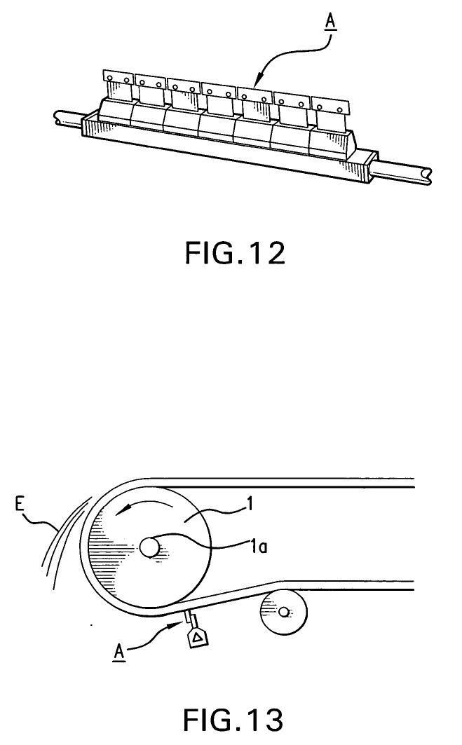

FIG. 11 illustrates the third embodiment of the belt cleaning device according to the present invention. It is so attached that both ends of the belt cleaner 12 are positioned upward, and the center part of the belt cleaner 12 is positioned downward so as to arrange the belt cleaner 12 in a V-shape in the front view.

In the embodiment in FIG. 11, it is desirable that both ends upward to the belt cleaner 2 are supported by a tension device (not shown), and the center position of the belt cleaner 2 is fixed by means of the fixing device 15.

The V-shaped arrangement as in FIG. 11 can be chiefly applied in the event that a diameter of the head pulley is relatively small and its length (the width of the conveyer belt 2) is large due to the reason that in such a case as seen in FIG. 1 it is difficult to make an inclination angle larger than 20°

Referring to FIG. 1, the head pulley 1 rotates in the direction of the arrow, and the conveyer belt 2 runs in the direction of the arrow, to discharge the conveyed E (not illustrated) on the conveyer belt from the front end of the head pulley 1 downward/forward. And, adherents Ea fastened to the outer surface of the conveyer belt 2 are peeled off by the tip edge 14c of the wear-resistant removing chip 14 and discharged downward.

In the event that contact resistance between the wear-resistant removing chips 14 and the conveyer belt 2 becomes excessive, the removing chips 14 move up opposing the elasticity of the tension adjustment spring 16c of the tension device, and rotate 180°, thus preventing the removing chip from being damaged.

It is determined by the actual operation tests that the useful service life has been extended 3-4 times compared to the case when a conventional blade type cleaner A is used.

When the wear-resistant removing chips 14 face the running direction of the conveyer belt 2 at the proper angle, cleaning effects are enhanced, and the wear speed of the removing chips is remarkably reduced.

Furthermore, even when the outer surface of the conveyer belt 2 is found not flat but curved, the removing chips 14 can be brought into an intimate contact with the outer surface of the conveyer belt 2 so that a certain cleaning effects can be expected. In addition, very little time is required for adjusting the belt cleaner 12, thus making it possible to realize a so-called maintenance-free belt cleaning device 11.

Feasibility of Industrial Use

The present invention can be utilized in the belt conveyer type commodities/substances transport systems used in such places as steel-making plants, mines, foundries, sewage disposal plants, earth and sand transport industries, cement factories, glass-making factories and the like.

While the present invention has been described with reference to certain preferred embodiments, one of ordinary skill in the art will recognize that additions, deletions, substitutions, modifications, and improvements can be made while remaining within the spirit and scope of the present invention as defined by the appended claims.

What is claimed is:

1. A wire rope type belt cleaning device for a conveyor belt, comprising:
a conveyor belt having a width and having a head pulley, the head pulley having an axis, and
a belt cleaner, the belt cleaner comprising:
a wire rope disposed at an inclination angle θ relative to the pulley axis, and
a plurality of wear-resistant removing chips fitted to the wire rope such that the chips are adjacent to each other and are in contact with the conveyor belt across the width of the conveyor belt.

2. A wire rope type belt cleaning device according to claim 1, wherein each said removing chip comprises a main body made of a nearly square thick plate, a horizontal hole in the main body for insertion of said wire rope, and recesses formed in each of two opposite sides of the main body.

3. A wire rope type belt cleaning device according to claim 1, wherein each said removing chip comprises a main body made of a nearly square thick plate with an arc-shaped or trapezoid-shaped cross-section, a horizontal hole in the main body for insertion of said wire rope, and a recess formed on a side of the main body opposed to said conveyor belt.

4. A wire rope type belt cleaning device according to claim 1, wherein said removing chips are composed substantially of ceramic and are fitted to permit rotation around the wire rope.

5. A wire rope type belt cleaning device according to claim 1, wherein said angle θ is greater than 20°.

6. A wire rope type belt cleaning device according to claim 1, wherein said belt cleaner is arranged in a V shape as seen from the front of said conveyor belt.

7. A wire rope type belt cleaning device according to claim 1, wherein said belt cleaner has two ends, one end of said belt cleaner being fixed to a fixing device and the other end of the belt cleaner being fixed to a tension device permitting adjustment of a level of tension of said belt cleaning device.

8. A wire rope type belt cleaning device according to claim 6, wherein said belt cleaner has two ends, each end being fixed to a tension device permitting adjustment of a level of tension of said belt cleaner, a center part of the belt cleaner being fixed to a fixing device.

9. A wire rope type belt cleaning device according to claim 1, wherein:
said head pulley has a circumference, and
said belt cleaner wraps partially around the circumference of said head pulley in contact with said conveyor belt.

10. A wire rope type belt cleaning device for a conveyor belt, comprising:
a conveyor belt having a width and having a head pulley, the head pulley having an axis and a circumference, and
a belt cleaner, the belt cleaner comprising:
a wire rope disposed at an inclination angle greater than 20° relative to the pulley axis, and
a plurality of wear-resistant removing chips fitted to the wire rope such that the chips are adjacent to each other, are fitted to permit rotation about the wire rope, and are in contact with the conveyor belt across the width of the conveyor belt, wherein the belt cleaner wraps partially around the circumference of the head pulley in contact with the conveyor belt.
